(19) United States
(12) Patent Application Publication
(10) Pub. No.: US 2019/0338861 A1
(43) Pub. Date: Nov. 7, 2019

(54) VALVE ARRANGEMENT

(71) Applicant: Hebmüller SRS Technik GmbH, Kaarst (DE)

(72) Inventor: Guido OTTERBEIN, Kaarst (DE)

(21) Appl. No.: 16/475,457

(22) PCT Filed: Nov. 9, 2017
(86) PCT No.: PCT/EP2017/078799

§ 371 Date: Jul. 2, 2019

(30) Foreign Application Priority Data
Jan. 6, 2017 (DE) 20 2017 100 041.9
Jan. 6, 2017 (DE) 20 2017 100 042.7

(51) Int. Cl. F16K 27/02; F16K 24/04; F16K 1/14

(52) U.S. Cl. CPC F16K 27/0245; F16K 1/14; F16K 27/0281; F16K 24/046

(57) ABSTRACT

A valve arrangement has a valve housing comprising lower and upper housing parts, in which a flow channel with a flow chamber is formed. A blocking device closes the flow channel. The housing parts can rotate relative to each other about a common vertical axis and are detachably connected. At least one transverse end channel section is formed in the lower housing part and extends transversely to the axis of rotation between an opening in the peripheral wall of the lower housing part for the inlet or outlet of fluid and a lower vertical channel section, and/or in the upper housing part a transversely extending end channel section is formed which extends transversely to the axis of rotation between an opening in the circumferential wall of the upper housing part for the inlet or outlet of fluid and an upper vertical channel section.

The present invention relates to a valve arrangement having a valve housing in which a flow channel is formed, said flow channel comprising a lower vertical channel section, an upper vertical channel section and a flow chamber disposed there between, and extending between an opening for inlet or outlet of a fluid and a further opening for inlet or outlet of a fluid of the valve housing, and having a blocking device assigned to the flow chamber for closing the flow channel, said blocking device comprising a valve seat surrounding the flow channel and a valve body, which is movable in the valve housing between an open position, in which the valve body is not in contact with the valve seat in order to open the flow channel, and a closed position, in which the valve body comes into sealing contact with the valve seat, the valve housing having a lower housing part and an upper housing part which are rotatable relative to each other about a common vertical axis of rotation.

Valve arrangements of this type are for example known as check valves from EP 1 319 878 B1 and are installed in fluid lines to ensure that a fluid can flow in the line only in one flow direction. In particular, such check valves are used in the low-pressure range in order to supply fresh water to sanitary facilities and to discharge waste water from them. It can be seen as disadvantageous, that the disclosed check valve only provides connections in the longitudinal direction of the flow channel. As a result it is not possible, in particular were space is limited, to design the connections in a flexible and space-saving way.

DE 20 2011 000 643 U1 discloses a check valve arrangement in which a vertical flow channel is closed by a spherical valve body. Axial and lateral outlet openings are provided in the housing, whereby further valve arrangements are connected in the region of the lateral outlet openings. These are mounted rotatably around the base body and can therefore be arranged flexibly in any direction to the base body. A disadvantage is here that the installation in defined relative positions is not possible, so that the risk of incorrect installation is high, in particular in difficult installation environments. As the fluid in the base body must flow from the vertical flow channel through a transverse bore and through a subsequent groove before arriving at a connected piece, multiple flow deflections and cross-sectional changes occur, creating the risk of significant pressure losses.

Often, very little space is available for the installation of such valve arrangements. This is particularly the case in galleys and toilets of commercial aircrafts.

The object of the invention is therefore to design a valve arrangement of the type mentioned at the beginning in such a way that it requires little space, can be used flexibly and the other disadvantages mentioned are avoided.

In a valve arrangement of the type mentioned at the beginning, this objective is solved by the fact that the lower housing part and the upper housing part are detachably connected to one another in defined relative positions, that at least one transversely extending end channel section is formed in the lower housing part and extends transversely to the axis of rotation between one opening for inlet or outlet of a fluid provided in the circumferential wall of the lower housing part and the lower vertical channel section, and/or that a transversely extending end channel section is formed in the upper housing part and extends transversely to the axis of rotation between one opening for inlet or outlet of a fluid provided in the circumferential wall of the upper housing part and the upper vertical channel section.

Because the two housing parts can be rotated relative to each other, different rotational positions of the openings for inlet and outlet of a fluid can be realized, if the openings for inlet and outlet of a fluid are formed in the lateral circumferential wall. In this way, the housing parts can be aligned with each other in such a way that the openings for inlet and outlet of a fluid of the valve arrangement are optimally positioned for the respective installation conditions.

According to an embodiment of the invention, at least one vertical end channel section of the flow channel is formed in the lower housing part and extends in the direction of the axis of rotation between one opening for inlet or outlet of a fluid provided in the bottom wall of the lower housing part and the lower vertical channel section or forms an end section thereof, and/or a vertical end channel section is formed in the upper housing part and extends in the direction of the axis of rotation between one opening for inlet or outlet of a fluid provided in the upper side of the upper housing part and the upper vertical channel portion or forms an end section thereof. In this embodiment at least one of the two housing parts is provided with an opening for inlet or outlet of a fluid which is oriented coaxially to the axis of rotation. In principle, it is possible, that only one opening for inlet or outlet of a fluid is provided in each of the two housing parts whereby one of the openings must be provided in the circumferential wall of the valve housing, whereas the opening in the other housing part can be either in the circumferential wall or coaxial with the axis of rotation. However, two openings for inlet or outlet of a fluid are preferably provided in each housing part, one opening being coaxial with the axis of rotation and the other being provided in the circumferential wall of the valve housing. This maximizes the variability of the valve arrangement.

According to an embodiment of the invention, it is provided that connection means are assigned to at least one transversely extending end channel section and/or vertical end channel section, via which connection means a connection branch assigned to the respective end channel section and inserted therein can be detachably connected to the valve housing. Preferably, at least one transversely extending and/or vertical end channel section is provided with an internal thread as connection means, into which a connection branch can be screwed or is screwed. This embodiment is based on the consideration not to provide the valve housing directly with attachment means for supply lines, but only to provide connection means by which a corresponding connection branch for a supply line can be detachably attached to the valve housing. This makes it possible to use different types of connection branches as needed, which can be mounted to the valve housing during installation.

In a further configuration of this embodiment, at least one opening for inlet or outlet of a fluid provided in the lower housing part and one opening for inlet or outlet of a fluid provided in the upper housing part are provided with a connection branch and each further opening for the inlet or outlet of a fluid present is sealingly closed by a cover which is inserted into the respective opening for inlet or outlet of a fluid and is detachably connected via the connection means to the valve housing, in particular screwed into the respective end channel section.

In this embodiment, the connection means for attaching connection branches to the valve housing are also used to provide covers of the valve housing which close the openings for inlet or outlet of a fluid not required.

In particular, if the connection means are formed as internal threads, it is useful to secure the connection branches and/or covers inserted into the openings for inlet or outlet of a fluid against rotation about an axis of the respective end channel section. It is easily possible to screw the components to the valve housing. Furthermore, according to an embodiment of the invention, it is provided that the connection branches and/or the covers are secured by securing means which can be detachably fasted, in particular screwed to the valve housing. The securing means on the one hand and the connection branches and/or the covers on the other hand can be designed in such a way that they engage in a force-fitting manner and/or in a form-fitting manner in order to prevent rotation.

In addition, a respective flattening in the circumferential wall of the valve housing can be assigned to each of the openings for inlet or outlet of a fluid provided in the circumferential wall of the valve housing, a radial projection or collar of the connection branch/cover inserted into the respective opening for inlet or outlet of a fluid coming into flat contact against said respective flattening.

Furthermore, the upper housing part and the lower housing part can be centered with respect to one another in the usual way. In particular, the lower housing part may have a centering collar and the upper housing part a centering recess which correspond to each other.

In a manner known per se, the upper housing part and the lower housing part can be screwed together. In this case, it is possible, to provide connecting flanges with corresponding through-holes for connection screws on the two housing parts. The number and positioning of the through-holes in the connection flanges determine the offset about which the two housing parts can be rotated against each other.

Alternatively, it may be provided that the lower housing part has a plurality of radial blind holes in the region of the centering collar, the upper housing part has radial through-openings in the region of the centering recess corresponding to the blind holes, and securing elements are provided which extend over the through-openings of the upper housing part and the blind holes of the lower housing part and those prevent the two housing parts from rotating relative to one another in a force-fitting and/or form-fitting manner.

In a preferred embodiment of the invention, it is intended that the blind holes formed in the region of the centering collar of the lower housing part have an internal thread and the securing elements are formed as fixing screws.

It is conceivable that the valve arrangement has a number of four securing elements at an equal distance from each other over its circumference, so that four defined relative positions of the two housing parts exists at an angel of rotation of 90° to each other. However, other divisions would also be possible, for example 3, 6 or 8 fixable relative positions of the two housing parts to each other.

Finally, the valve seat is conveniently formed in the upper housing part and the valve body is formed as a ball made of a material that can float in water. Advantageously, the housing parts and the valve body essentially consist of non-metallic materials, in particular ceramics and/or plastics.

In addition, it is intended to use the valve arrangement according to the invention as a check valve, the openings for inlet or outlet of a fluid formed in the lower housing part serving as outlet openings and the openings for inlet or outlet of a fluid formed in the upper housing part serving as inlet openings.

An alternative use of the valve arrangement is provided as a venting valve, at least one of the openings for inlet or outlet of a fluid formed in the lower housing part serving as an inlet opening for a fluid and the openings for inlet or outlet of a fluid formed in the upper housing part serving as outlet openings for a fluid.

In addition, the invention comprises a method for configuring a valve arrangement according to the invention, comprising the steps below:
Connecting the connection branch and/or cover to the end channel sections of the lower housing part;
Connecting the connection branch and/or cover to the end channel sections of the upper housing part;
securing the connection branches and/or covers against unintentional loosening by means of the securing means; and
Turning the lower housing part relative to the upper housing part into the relative position to one another intended for operation, and fixing the two housing parts to one another by means of the securing elements.

The steps described above for configuring a valve arrangement can also be carried out in a different sequence than that shown.

With regard to further advantages embodiments of the invention, reference is made to the subclaims as well as to the following description of an embodiment with reference to the enclosed drawing. The drawing shows

FIG. 1 a valve arrangement according to the present invention in a perspective view,

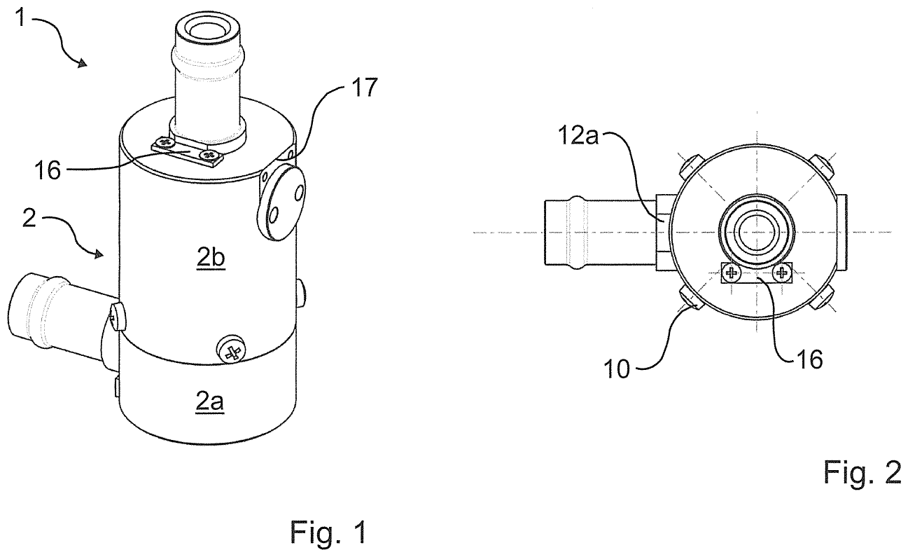

FIG. 2 the valve arrangement from FIG. 1 in a plan view,

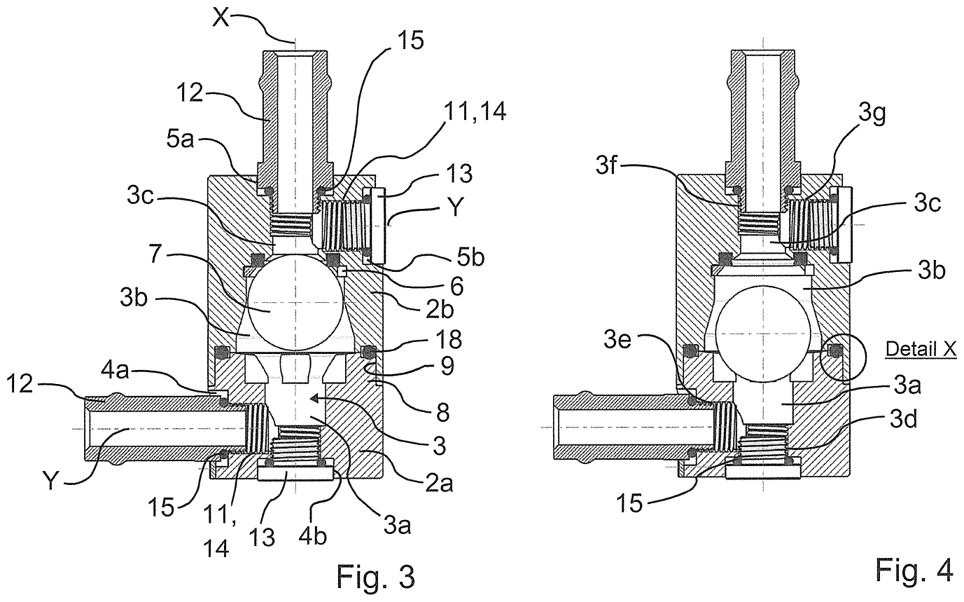

FIG. 3 the valve arrangement in closed position in a longitudinal sectional view,

FIG. 4 the arrangement from FIG. 3 with the valve in open state,

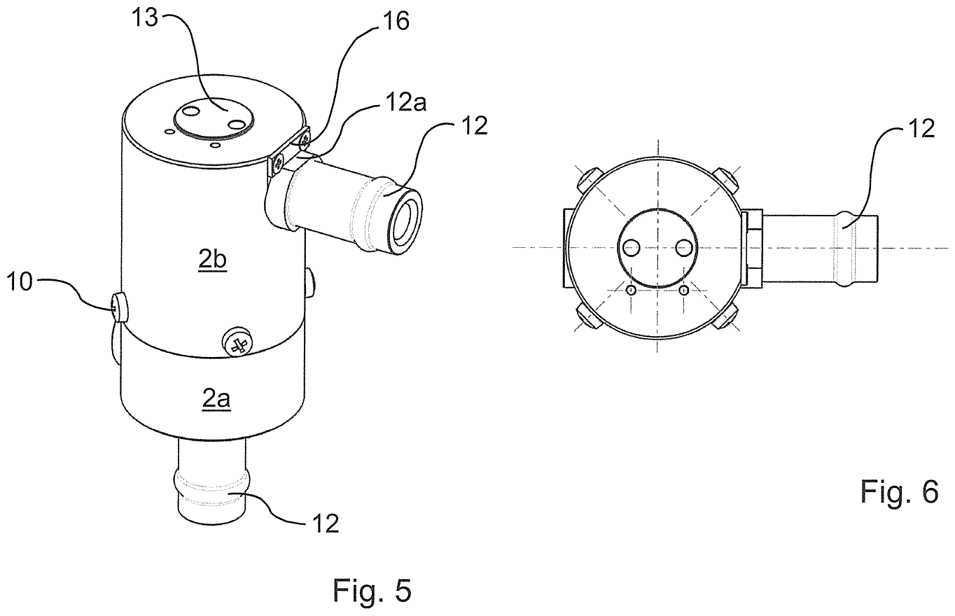

FIG. 5 the valve arrangement in a second application version in a perspective view,

FIG. 6 the valve arrangement from FIG. 5 in a plan view,

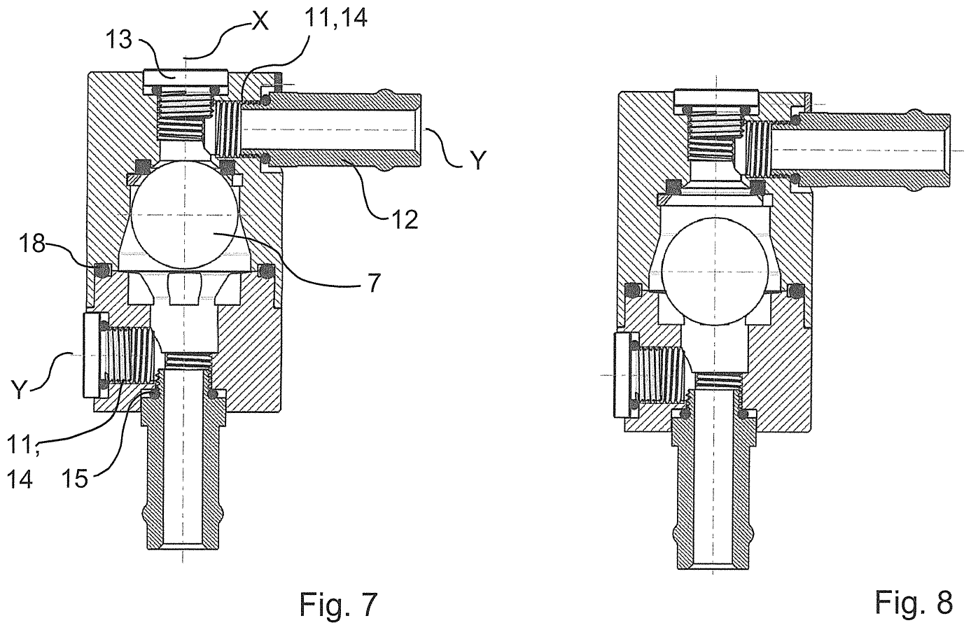

FIG. 7 the valve arrangement from FIG. 5 in closed state in a longitudinal sectional view,

FIG. 8 the longitudinal sectional view form FIG. 7 with the valve in open state,

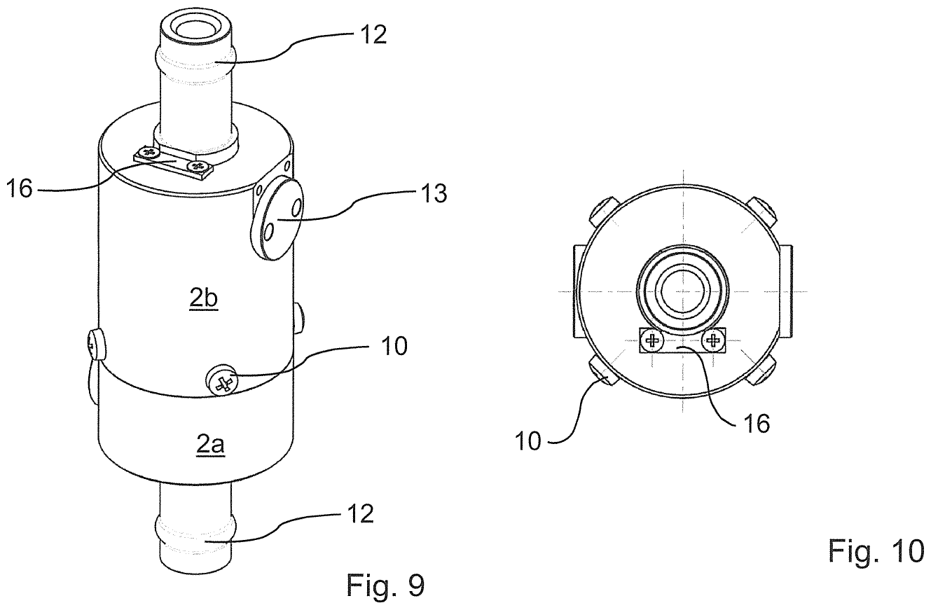

FIG. 9 the valve arrangement in a third application version in a perspective view,

FIG. 10 the valve arrangement from FIG. 9 in a plan view,

FIG. 11 the valve arrangement from FIG. 9 in closed state in a longitudinal sectional view,

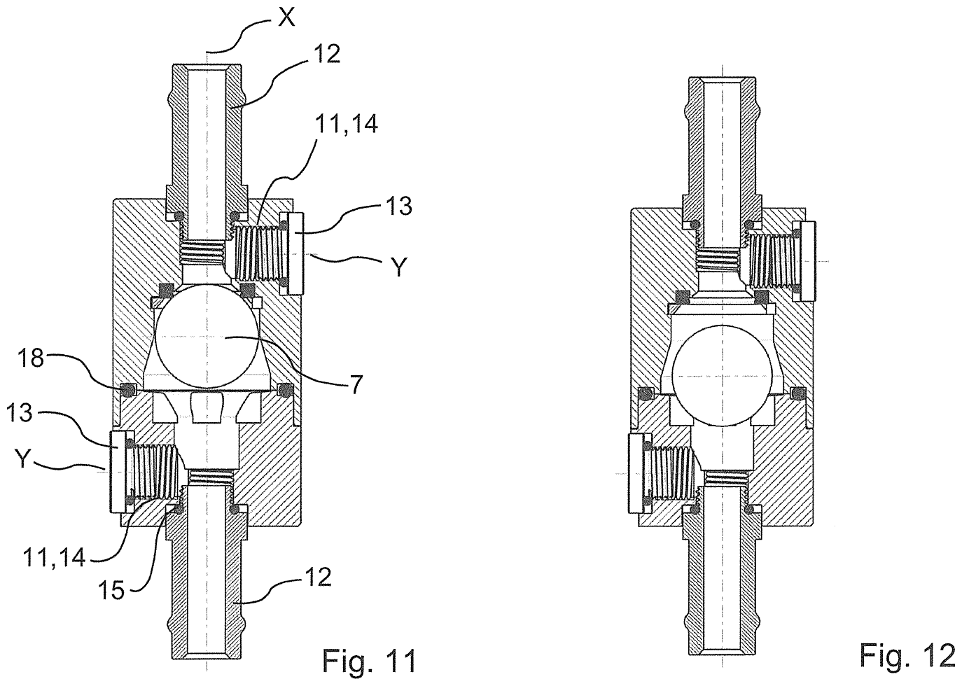

FIG. 12 the longitudinal sectional view from FIG. 11 with the valve in open state,

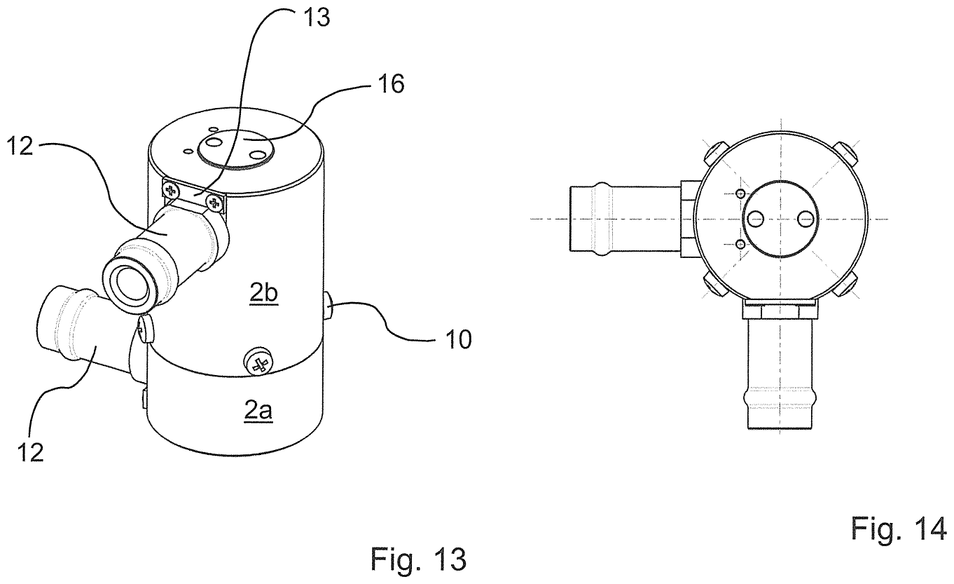

FIG. 13 the valve arrangement in a force application version in a perspective view,

FIG. 14 the valve arrangement from FIG. 13 in a plan view,

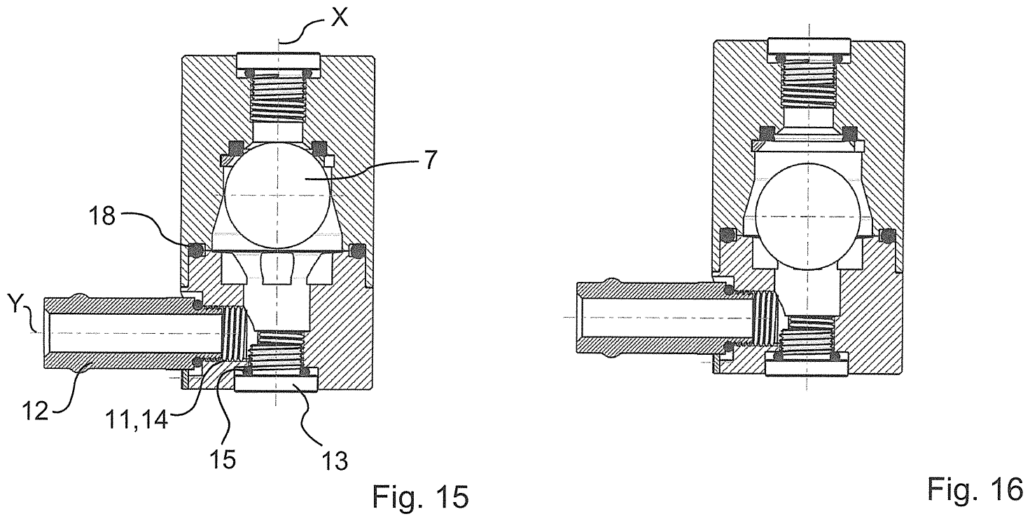

FIG. 15 the valve arrangement from FIG. 13 in closed state in a longitudinal sectional view,

FIG. 16 the longitudinal sectional view from FIG. 15 with the valve in open state,

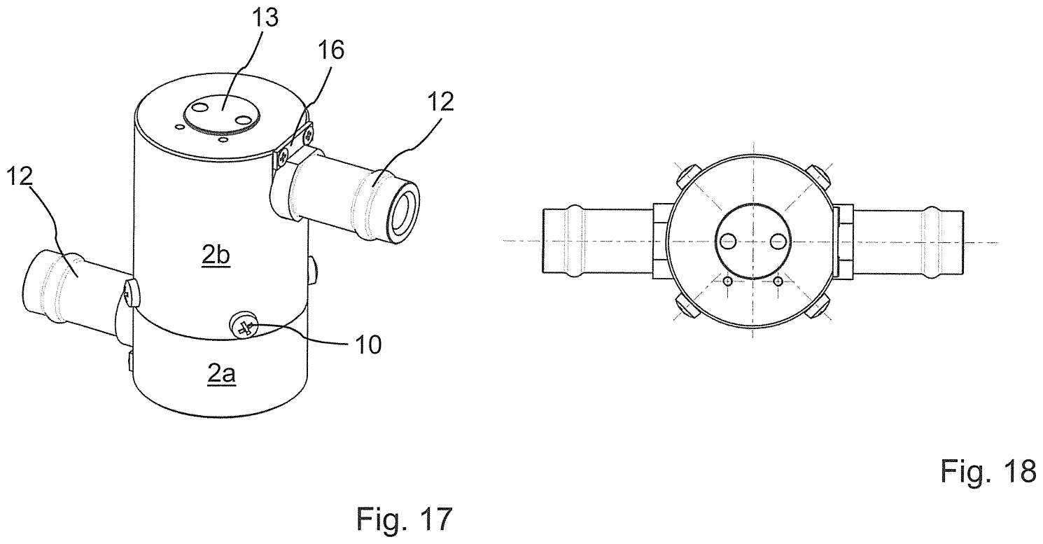

FIG. 17 the valve arrangement in a fifth application version in a perspective view,

FIG. 18 the valve arrangement from FIG. 17 in a plan view,

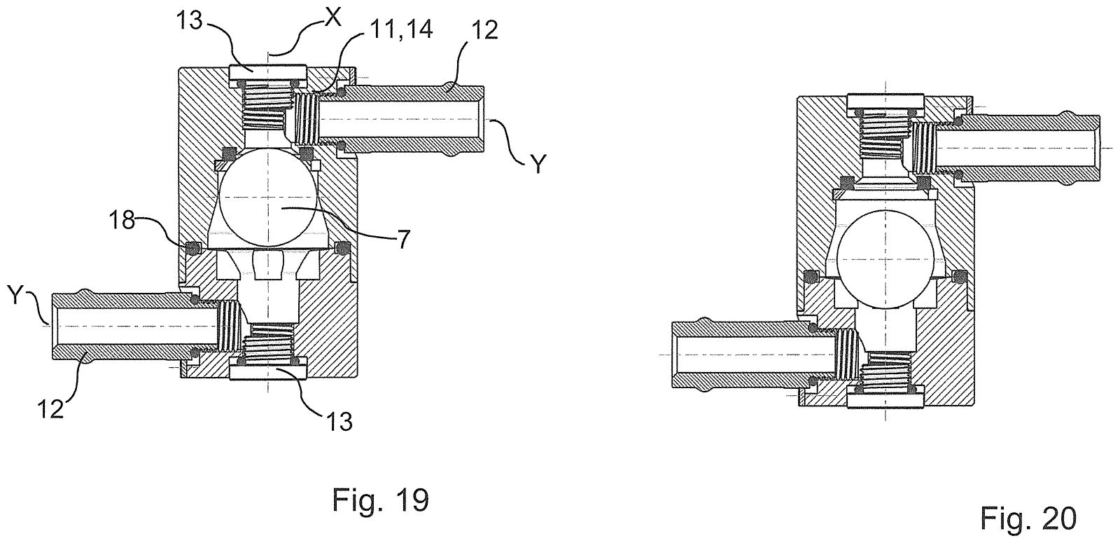

FIG. 19 the valve arrangement from FIG. 17 in closed state in a longitudinal sectional view,

FIG. 20 the longitudinal sectional view from FIG. 19 with the valve in open state,

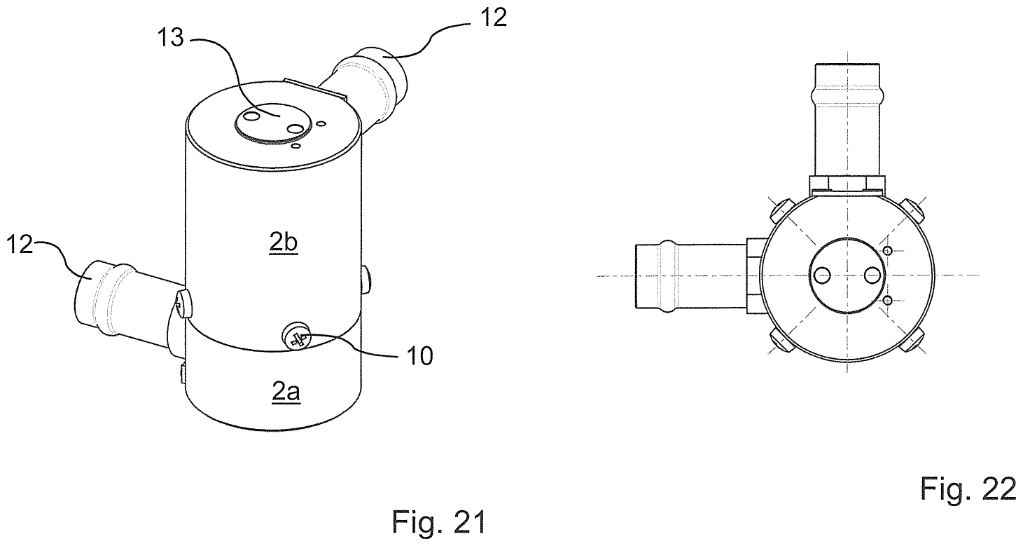

FIG. 21 the valve arrangement in a sixth application version in a perspective view,

FIG. 22 the valve arrangement from FIG. 21 in a plan view,

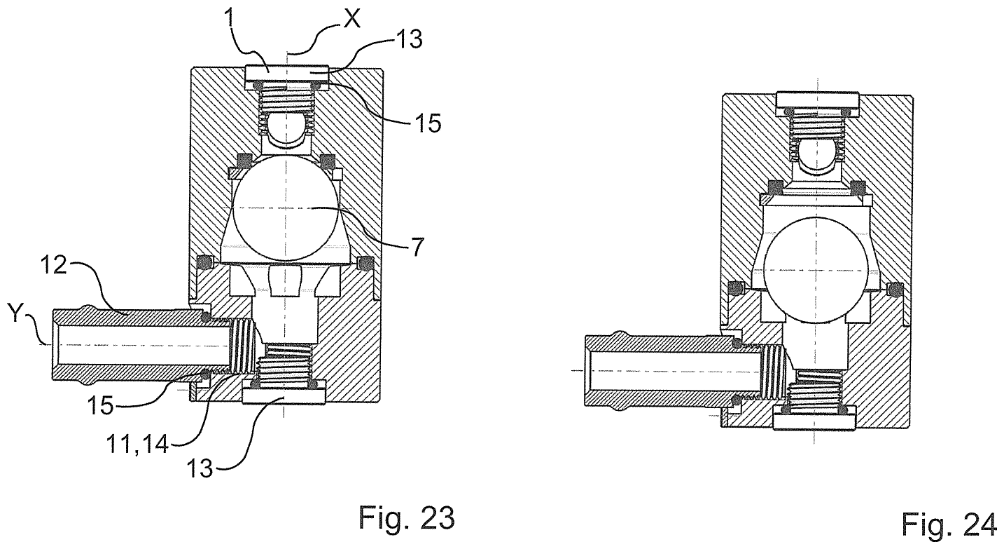

FIG. 23 the valve arrangement from FIG. 21 in closed state in a longitudinal sectional view,

FIG. 24 the longitudinal sectional view from FIG. 23 with the valve in open state,

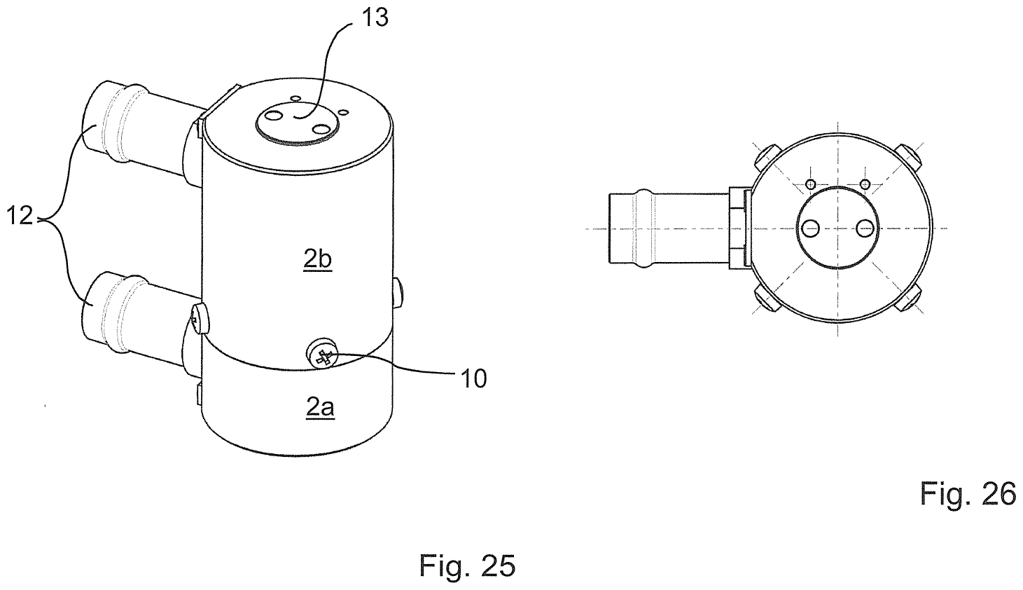

FIG. 25 the valve arrangement in a seventh application version in a perspective view,

FIG. 26 the valve arrangement from FIG. 25 in a plan view,

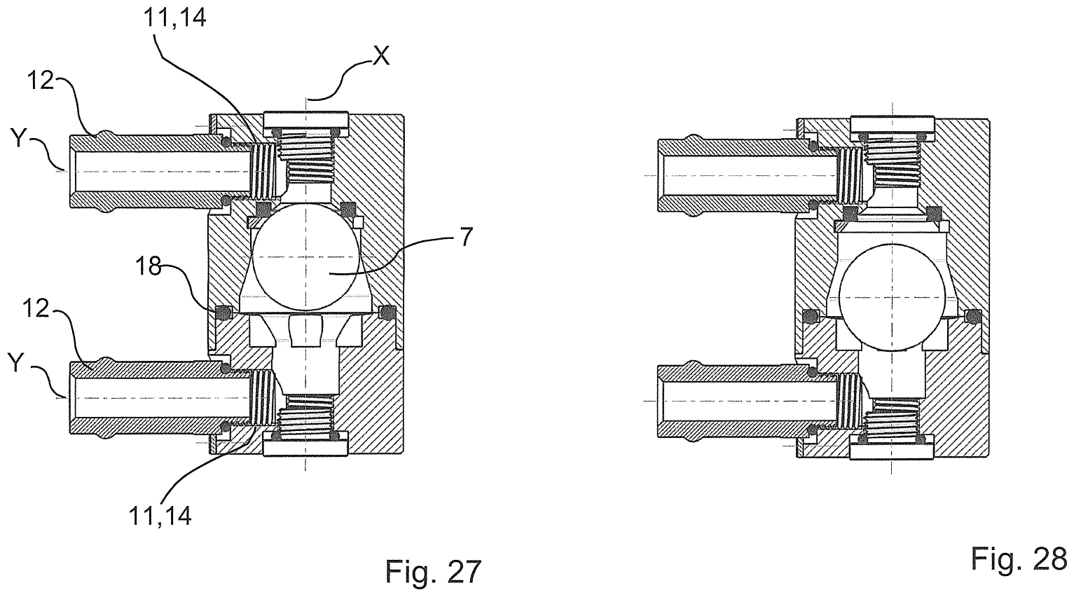

FIG. 27 the valve arrangement from FIG. 25 in the closed state in a longitudinal sectional view,

FIG. 28 the longitudinal sectional view from FIG. 27 with the valve in open state, and

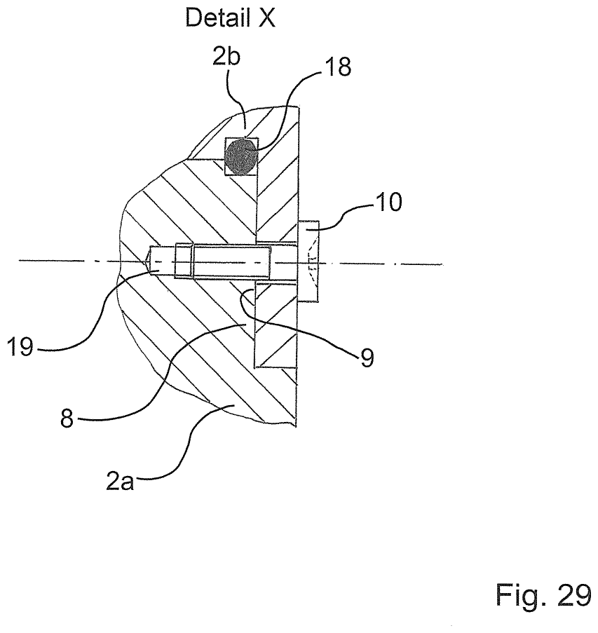

FIG. 29 a detailed sectional view of the housing parts in the region of the centering collar.

The drawing shows a valve arrangement 1 according to the present invention, which can be installed vertically in the pipeline of a low-pressure water system, for example, in the manner shown. The valve arrangement can be used as a check valve, with the flow direction from top to bottom. Alternatively, the valve arrangement can be used as a venting valve, whereby the flow direction is reversed. The valve arrangement 1 has a valve housing 2, which is substantially formed by a lower housing part 2a and an upper housing part 2b. A flow channel 3 is formed in the valve housing 2 and extends in a substantially vertical direction between an opening for inlet or outlet of a fluid 4a, 4b at the lower housing part 2a and an opening for inlet or outlet of a fluid 5a, 5b at the upper housing part 2b.

The flow channel 3 comprises a lower vertical channel section 3a provided in the lower housing part 2a, followed by an equally vertical flow chamber 3b, which has a considerably larger diameter than the lower vertical channel section 3a and is formed between the housing parts 2a, 2b. Furthermore, the flow channel 3 comprises an upper vertical channel section 3c which is connected to the flow chamber 3b at the top. The vertical channel sections 3a, 3c and the flow chamber 3b are arranged concentrically to each other.

In the transition region between the upper vertical channel section 3c and the flow chamber 3b, a valve seat 6 is formed in the upper housing part 2a surrounding the upper vertical channel section 3a. In the flow chamber 3b, a valve body 7 is provided in the form of a ball made of a floatable material, for example a plastic or a ceramic, the valve body 7 being movable in the vertical direction between a lower open position and an upper closed position, in which the valve body comes into sealing contact with the valve seat 6.

The lower vertical channel section 3a, the flow chamber 3b and the upper vertical channel section 3c of the valve housing 2 define a vertical longitudinal axis X with respect to which the two housing parts 2a, 2b are centered. Therefore, a centering collar 8 is provided on the lower housing part 2a and a corresponding centering recess 9 is provided on the upper housing part 2b in such a way that the two housing parts 2a, 2b can be plugged together axially, the upper housing part 2b embracing the lower housing part 2a in the plugged state. In the axial overlap region, the two housing parts 2a, 2b are screwed together. Several fixing screws 10 are provided for this purpose. These penetrate through-openings that are provided in the upper housing part 2b with a uniform offset to each other, and are screwed into corresponding threaded holes located in the centering collar of the lower housing part 2a. The arrangement is such that the housing parts 2a, 2b can be turned against each other after loosening the fixing screws 10 about the longitudinal axis X and can be reconnected in the turned relative position.

The gap between the housing parts 2a, 2b is sealed by a sealing element 18.

As it can be clearly seen in the figures, the lower housing part 2a has in total two openings for inlet or outlet of a fluid 4a, 4b, and in the same way the upper housing part 2b has in total two openings for inlet or outlet of a fluid 5a, 5b. The arrangement is such that one opening 4b in the underside of the lower housing part 2a is arranged concentrically to the longitudinal or rotational axis X and thus concentrically aligned to the lower vertical channel section 3a and is connected to this via a vertical end channel section 3d concentrically with the longitudinal axis. The further opening 4a is provided in the circumferential wall of the lower housing part 2a and connected to the lower vertical channel section 3a via a transversely extending end channel section 3e, which extends transversely to the longitudinal axis X. In the embodiment shown, the axis Y of the end channel section 3e extends in the radial direction.

In the same way, an opening for inlet or outlet of a fluid 5a is formed concentrically to the longitudinal axis X in the upper side of the upper housing part 2b and is connected to this via a vertical end channel section 3f concentrically to the longitudinal axis X. The further opening for inlet or outlet of a fluid 5b is formed in the circumferential wall of the upper housing part and is connected to the upper vertical channel section 3c via a transversely extending end channel section 3g which extends transversely to the longitudinal axis X. In concrete terms, the axis Y of the end channel section 3g runs in a radial direction.

All end channel sections 3d, 3e and end channel sections 3f, 3g are provided with an internal thread 11, so that optionally a connection branch 12 or a cover 13 for closing the respective opening for inlet or outlet of a fluid 4a, 4b; 5a, 5b, which are provided with a corresponding external thread 14, can be screwed into the end channel sections 3d, 3e, 3f, 3g. The annular gaps formed between the valve housing and the components 12, 13 screwed-in are sealed by sealing rings 15 which are pushed onto the external threads 14.

The fact that the lower housing part 2a and the upper housing part 2b each have a plurality of openings for inlet or outlet of a fluid 4a, 4b; 5a, 5b and corresponding end channel sections 3d, 3e and end channel sections 3f, 3g, respectively, and, in addition, the lower housing part 2a and the upper housing part 2b are rotatable relative to one another about the vertical longitudinal axis X results in different versions of application which are shown in the figures.

FIGS. 1 to 4 show a first application version in which the bottom opening 4b is closed by a cover 13 and a connection branch 12 is screwed into opening 4a of the circumferential wall. On the other hand, a connection branch is screwed into opening 5a on the upper side of the upper housing part 2b and the further lateral opening 5b is closed by a cover 13.

In the second application version shown in FIGS. 5 to 8, the arrangement is reversed. A connection branch 12 is screwed into the bottom opening 4b, whereas the lateral opening 4a is closed by a cover 13. On the other hand, the opening 5a of the upper side of the upper housing part 2b is closed by a cover 14 and a connection branch 12 is fitted to the lateral opening.

In the third application version shown in FIGS. 9 to 12, a lateral opening 4a and the lateral opening 5b are closed by a cover 13 and the connection branches 12 are attached to the other openings 4b and 5a.

In contrast, the fourth application version shown in FIGS. 13 to 16, connection branches 12 are attached to the lateral openings 4a, 5b, whereas openings 5a, 4b are closed at the top and bottom of the housing by covers 13. The lower housing part 2a and the upper housing part 2b are aligned in such a way that the connection branches are turned 90° to each other. FIGS. 17 to 20 show that same arrangement, except that in this fifth application version the housing parts 2a, 2b are aligned in such a way that the connection branches 12 are twisted 180° against each other, i.e. pointing away from each other.

The sixth application version shown in FIGS. 21 to 24 corresponds to the fourth application version with the proviso that the connection branches 12 are turned 90° in the opposite direction.

In the seventh application version shown in FIGS. 25 to 28, the housing parts 2a, 2b are finally aligned in such a way that the connection branches 12 provided at the lateral openings 4a, 5b point in the same direction.

As can be seen in the drawing, measures have been taken to prevent the connection branch 12 from twisting about it axis X. For this purpose, securing plates 16 are provided, which are screwed to the valve housing 2 and interact in a form-fitting manner with a flattening on a radial collar 12a of the connection branches 12, with which the connection branches 12 come into contact on the outside of the valve housing 2, in order to prevent twisting of the connection branches. Finally, flattenings 17 are assigned to the openings for inlet or outlet of a fluid 5b, 4a in the circumferential wall of the valve housing 2, the radial collars 12a of the connection branches 12 and the covers 13 coming into flat contact with the flattenings 17.

FIG. 29 shows the securing of the two housing parts against twisting. The lower housing part 2a contains threaded blind holes 19 in the area of the centering collar 8, to which through-openings are correspondingly arranged in the upper housing part 2b, and into which fixing screws 10 can be screwed to prevent the housing parts 2a, 2b from turning relative to each other by means of a form-fitting and/or a force-fitting securing.

1. Valve arrangement having
a valve housing (2) in which a flow channel (3) is formed, said flow channel (3) comprising a lower vertical channel section (3a), an upper vertical channel section (3c) and a flow chamber (3b) disposed therebetween, and extending between an opening for inlet or outlet of a fluid (4a, 4b) and a further opening for inlet or outlet of a fluid (5a, 5b) of the valve housing (2), and having
a blocking device assigned to the flow chamber (3b) for closing the flow channel (3), said blocking device comprising a valve seat (6) surrounding the flow channel (3) and a valve body (7), which is movable in the valve housing (2) between an open position, in which the valve body (7) is not in contact with the valve seat (6) in order to open the flow channel (3), and a closed position, in which the valve body (7) comes into sealing contact with the valve seat (6),
the valve housing (2) having a lower housing part (2a) and an upper housing part (2b) which are rotatable relative to each other about a common vertical axis of rotation (X),
wherein
the lower housing part (2a) and the upper housing part (2b) are detachably connected to one another in defined relative positions,
wherein at least one transversely extending end channel section (3e) is formed in the lower housing part (2a) and extends transversely to the axis of rotation (X) between one opening for inlet or outlet of a fluid (4a) provided in the circumferential wall of the lower housing part (2a) and the lower vertical channel section (3a), and/or
wherein a transversely extending end channel section (3f) is formed in the upper housing part (2b) and extends transversely to the axis of rotation (X) between one opening for inlet or outlet of a fluid (5b) provided in the circumferential wall of the upper housing part (2b) and the upper vertical channel section (3c).

2. Valve arrangement according to claim 1, wherein at least one vertical end channel section (3d) of the flow channel (3) is formed in the lower housing part (2a) and extends in the direction of the axis of rotation (X) between one opening for inlet or outlet of a fluid (4b) provided in the bottom wall of the lower housing part (2a) and the lower vertical channel section (3a) or forms an end section thereof, and/or in that a vertical end channel section (3f) is formed in the upper housing part (2b) and extends in the direction of the axis of rotation (X) between one opening for inlet or outlet of a fluid (5a) provided in the upper side of the upper housing part (2b) and the upper vertical channel portion (3c) or forms an end section thereof.

3. Valve arrangement according to claim 1, wherein connection means (11) are assigned to at least one transversely extending end channel section (3e, 3g) and/or vertical end channel section (3d, 3f), via which connection means (11) a connection branch (12) assigned to the respective end channel section (3d, 3e, 3f, 3g) and inserted therein can be detachably connected to the valve housing (2).

4. Valve arrangement according to claim 3, wherein at least one transversely extending and/or vertical end channel section (3d, 3e, 3f, 3g) is provided with an internal thread (11) as connection means, into which a connection branch (12) can be screwed or is screwed.

5. Valve arrangement according to claim 3, wherein at least one opening for inlet or outlet of a fluid (4a, 4b) provided in the lower housing part (2a) and one opening for inlet or outlet of a fluid (5a, 5b) provided in the upper housing part (2b) are provided with a connection branch (12) and each further opening for the inlet or outlet of a fluid present is sealingly closed by a cover (13) which is inserted into the respective opening for inlet or outlet of a fluid and is detachably connected via the connection means to the valve housing (2), in particular screwed into the respective end channel section (3d, 3e, 3f, 3g).

6. Valve arrangement according to claim 5, wherein connection branches (12) and/or covers (13) inserted into the openings for inlet or outlet of a fluid (4a, 4b, 5a, 5b) are secured against rotation about an axis of the end channel section to which they are respectively assigned.

7. Valve arrangement according to claim 6, wherein the connection branches (12) and/or the covers (13) are secured by securing means (16), which can be detachably fastened, in particular screwed to the valve housing (2), the securing means (16) on the one hand and the connecting branches (12) and/or the covers (13) on the other hand being designed in such a way that they engage in a force-fitting manner and/or in a form-fitting manner in order to prevent rotation.

8. Valve arrangement according to claim 7, wherein a respective flattening (17) in the circumferential wall is assigned to each of the openings for inlet or outlet of a fluid (4a, 5b) provided in the circumferential wall of the valve housing, a radial projection or collar of the connection branch/cover (12, 13) inserted into the respective opening for inlet or outlet of a fluid coming into flat contact against said respective flattening (17).

9. Valve arrangement according to claim 1, wherein the upper housing part (2b) and the lower housing part (2a) are centered with respect to one another.

10. Valve arrangement according to claim 9, wherein
the lower housing part (2a) has a centering collar (8) and the upper housing part (2b) has a centering recess (9) corresponding thereto,
the lower housing part (2a) has a plurality of radial blind holes (19) in the region of the centering collar (8),
the upper housing part (2b) has radial through-openings corresponding to the blind holes (19) in the region of the centering recess (9), and
securing elements are provided which extend over the through-openings of the upper housing part (2b) and the blind holes (19) of the lower housing part (2a) and thus prevent the two housing parts (2a, 2b) from rotating relative to one another in a force-fitting and/or form-fitting manner.

11. Valve arrangement according to claim 10, wherein the blind holes (19) formed in the region of the centering collar (8) of the lower housing part (2a) have an internal thread and the securing elements are formed as fixing screws (10).

12. Valve arrangement according to claim 1, wherein the valve seat (6) is formed in the upper housing part (2a).

13. Valve arrangement according to claim 1, wherein the valve body (7) is formed as a ball.

14. Valve arrangement according to claim 1, wherein the housing parts (2a, 2b) and the valve body (7) essentially consist of non-metallic materials, in particular ceramics and/or plastics.

15. Use of a valve arrangement according to claim 1 as a check valve, wherein the openings for inlet or outlet of a fluid (4a, 4b) formed in the lower housing part (2a) serve as outlet openings and the openings for inlet or outlet of a fluid (5a, 5b) formed in the upper housing part (2b) serve as inlet openings.

16. Use of the valve arrangement according to claim 1 as a venting valve, wherein at least one of the openings for inlet or outlet of a fluid (4a, 4b) formed in the lower housing part (2a) serves as an inlet opening for a fluid and the openings for inlet or outlet of a fluid (5a, 5b) formed in the upper housing part (2b) serve as outlet openings for a fluid.

17. Method for configuring a valve arrangement according to claim 1, comprising the steps below:
Connecting the connection branch (12) and/or cover (13) to the end channel sections (3d, 3e) of the lower housing part (2a);
Connecting the connection branch (12) and/or cover (13) to the end channel sections (3f, 3g) of the upper housing part (2b);
securing the connection branches (12) and/or covers (13) against unintentional loosening by means of the securing means (16); and
Turning the lower housing part (2a) relative to the upper housing part (2b) into the relative position to one another intended for operation, and fixing the two housing parts to one another by means of the securing elements.
